(19) United States
(12) Patent Application Publication
(10) Pub. No.: US 2008/0090522 A1
(43) Pub. Date: Apr. 17, 2008

(54) DISPLAY APPARATUS AND DISPLAY METHOD

(75) Inventor: Shigeki OYAMA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/869,940

(22) Filed: Oct. 10, 2007

(30) Foreign Application Priority Data
Oct. 11, 2006 (JP) 2006-277929

(51) Int. Cl. H04B 7/00

(52) U.S. Cl. 455/41.2

(57) ABSTRACT

A DSRC in-vehicle communication apparatus (1) operates as a base station based on the DSRC communication standard when a base station function section (3) is selected by an operation function selection section (2), and operates as a mobile station based on the DSRC communication standard when a mobile station function section (4) is selected. After a plurality of vehicles equipped with a DSRC in-vehicle communication apparatus (1) have been disposed, an inter-vehicle communication system is constructed by the function of each DSRC in-vehicle communication apparatus (1) being selected, and vehicles whose function has been selected as base station or mobile station performing DSRC communication.

### CROSS REFERENCE TO RELATED APPLICATIONS

The disclosures of Japanese Patent Application No. 2006-277929 filed on Oct. 11, 2006, including the specifications, drawings and abstracts are incorporated herein by reference in their entirety.

### BACKGROUND OF THE INVENTION

1. Field of the Invention

The present invention relates to an inter-vehicle communication method and in-vehicle communication apparatus that perform DSRC (Dedicated Short Range Communication) communication.

2. Description of the Related Art

The current DSRC communication standard (ARIB STD-T75) is used for implementing various ITS services such as fee payment and data/information two-way communication. With regard to DSRC (Dedicated Short Range Communication), “short-range communication system standard ARIB STD-T75” has been drawn up by the incorporated company “Association of Radio Industries and Businesses.” In this description, communication in accordance with this “short-range communication system standard ARIB STD-T75” is referred to as DSRC communication.

Conventionally, when communication is performed in accordance with the DSRC communication standard, a DSRC roadside device operating as a base station transmits FCMC (Frame Control Message Channel) data, which is DSRC communication frame configuration information, to a DSRC in-vehicle communication apparatus operating as a mobile station. The DSRC in-vehicle communication apparatus receives FCMC data transmitted by the DSRC roadside device and performs a frequency selection operation. After confirming that the selected frequency is correct, the DSRC in-vehicle communication apparatus transmits to the DSRC roadside device an ACTC (Activation Control Channel) signal containing link address data specifying the DSRC in-vehicle communication apparatus using a slot defined by the received FCMC data. Then the DSRC roadside device recognizes the link address of the DSRC in-vehicle communication apparatus by means of the link address data contained in the received ACTC signal.

Next, after recognizing the link address, the DSRC roadside device transmits FCMC data assigning transmit/receive slots to individual DSRC in-vehicle communication apparatuses. By this means, point-to-point communication becomes possible between a DSRC roadside device and DSRC in-vehicle communication apparatus.

However, with this kind of conventional DSRC communication standard, there is a difference in the slot types handled in a receive operation and transmit operation of a DSRC roadside device operating as a base station and a receive operation and transmit operation of a DSRC in-vehicle communication apparatus operating as a mobile station.

Therefore, according to the conventional DSRC communication standard, only communication performed between a DSRC roadside device and DSRC in-vehicle communication apparatus—that is, communication between road and vehicle—is stipulated, and communication between DSRC roadside devices (base stations) and communication between DSRC in-vehicle communication apparatuses (mobile stations) are not stipulated. Therefore, link connection and communication cannot be performed between DSRC roadside devices or between DSRC in-vehicle communication apparatuses.

There is thus a problem in that inter-vehicle communication cannot be performed according to the conventional DSRC communication standard.

In order to perform inter-vehicle communication within this current DSRC communication standard, it has been proposed that a vehicle equipped with a DSRC in-vehicle communication apparatus operating as a base station—for example, a vehicle provided with an advertising function—should be provided beforehand as a special vehicle, and this special vehicle should execute inter-vehicle communication by communicating with a vehicle equipped with a DSRC in-vehicle communication apparatus operating as a mobile station (see, for example, Unexamined Japanese Patent Publication No. 2004-221636).

However, in the invention according to Patent Document 1, one vehicle is fixed as a special vehicle with a base station function, and there is a problem in that inter-vehicle communication cannot be performed using DSRC communication between arbitrary vehicles.

### SUMMARY OF THE INVENTION

The present invention proposes an inter-vehicle communication method and in-vehicle communication apparatus that enable inter-vehicle communication to be performed using DSRC communication between arbitrary vehicles.

One aspect of an inter-vehicle communication method of the present invention achieves the above object by having: a frame control signal transmitting step of one of a plurality of in-vehicle communication apparatuses having functions of both a base station and a mobile station transmitting a frame control signal; a step of the in-vehicle communication apparatus that receives the frame control signal during a frame control signal reception standby operation analyzing the received frame control signal; a step of, when the in-vehicle communication apparatus that transmitted the frame control signal can be recognized by means of the analysis, transmitting a channel affiliation request signal containing the station's own address; a step of the in-vehicle communication apparatus that transmitted the frame control signal receiving the channel affiliation request signal during a channel affiliation request reception standby operation and functioning as a base station correspondent in-vehicle communication apparatus; and an inter-vehicle communication step of the base station correspondent in-vehicle communication apparatus and a mobile station correspondent in-vehicle communication apparatus that is the in-vehicle communication apparatus of the address of the channel affiliation request signal performing dedicated short-range communication.

Also, one aspect of an in-vehicle communication apparatus of the present invention achieves the above object by having: an operation function selection section that selects operation as a mobile station on receiving a frame control signal during a frame control signal reception standby operation, and selects operation as a base station on receiving a channel affiliation request signal during channel affiliation request signal reception standby after transmitting the frame control signal; a base station function implementation section that, when operation as a base station has been selected by the operation function selection section, performs communication with the mobile station of the address contained in the received channel affiliation request signal; and a mobile station function implementation section that, when operation as a mobile station has been selected by the operation function selection section, transmits the channel affiliation request signal containing the station's own address when a base station can be recognized by analyzing the received frame control signal, and performs communication with the base station.

According to the present invention, inter-vehicle communication using DSRC communication can be performed between arbitrary vehicles.

### BRIEF DESCRIPTION OF THE DRAWINGS

FIG. 1 is a block diagram showing the configuration of a DSRC in-vehicle communication apparatus according to Embodiment 1 of the present invention;

FIG. 2 is a drawing explaining the operation of an inter-vehicle communication system according to Embodiment 1 of the present invention;

FIG. 3 is a drawing explaining the operation of an inter-vehicle communication system according to Embodiment 2 of the present invention; and

FIG. 4 is a drawing explaining the operation of an inter-vehicle communication system according to Embodiment 3 of the present invention.

### DETAILED DESCRIPTION OF THE PREFERRED EMBODIMENTS

With reference now to the accompanying drawings, embodiments of the present invention will be explained in detail below.

### Embodiment 1

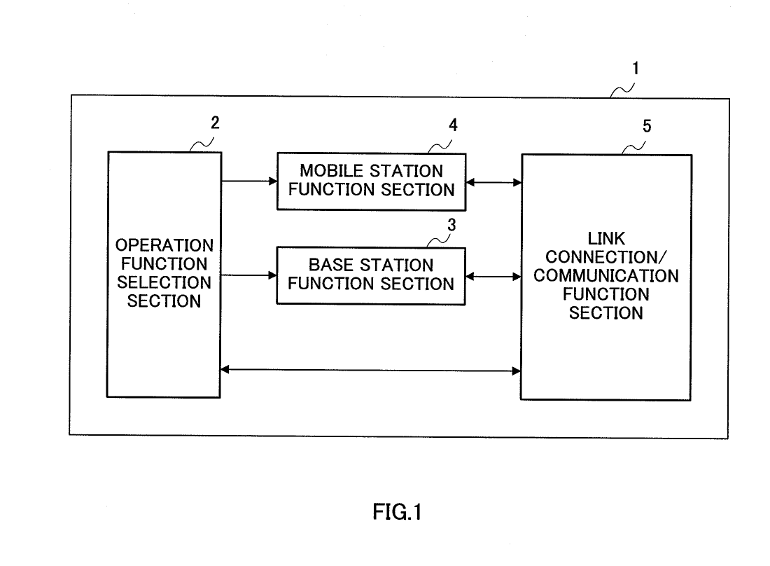

FIG. 1 is a block diagram showing the configuration of a DSRC in-vehicle communication apparatus according to Embodiment 1 of the present invention. DSRC in-vehicle communication apparatus 1 is mainly composed of an operation function selection section 2, a base station function section 3, a mobile station function section 4, and a link connection/communication function section 5.

Operation function selection section 2 selects base station function section 3 or mobile station function section 4 by means of a setting operation by the user of DSRC in-vehicle communication apparatus 1, or by means of a user setting operation plus DSRC communication with another DSRC apparatus, thereby selecting whether DSRC in-vehicle communication apparatus 1 operates as a base station or a mobile station. Specifically, operation function selection section 2 performs sequential and repeated control of a frame control signal transmit operation, frame control signal standby operation, and channel affiliation reception signal reception standby operation in DSRC communication, and when a frame control signal is received during a frame control signal standby operation, selects operation as a mobile station. When operation function selection section 2 selects operation as a mobile station, mobile station function section 4 is selected. When a channel affiliation request signal is received during channel affiliation request signal reception standby after transmitting a frame control signal, operation function selection section 2 selects operation as a base station. When operation function selection section 2 selects operation as a base station, base station function section 3 is selected.

Base station function section 3 implements base station function in DSRC communication in accordance with a selection by operation function selection section 2. Specifically, when selected by operation function selection section 2, base station function section 3 performs communication with the mobile station of the address contained in the received channel affiliation request signal via link connection/communication function section 5.

Mobile station function section 4 implements a DSRC communication mobile station function in accordance with a selection by operation function selection section 2. Specifically, when selected by operation function selection section 2, mobile station function section 4 analyzes a received frame control signal. Then, if a base station can be recognized by analyzing the frame signal, mobile station function section 4 transmits a channel affiliation request signal containing its own address via link connection/communication function section 5, and communicates with the base station.

Link connection/communication function section 5 is linked to operation function selection section 2, base station function section 3, and mobile station function section 4, and performs link connection and DSRC communication to another DSRC communication apparatus.

Next, the configuration of DSRC in-vehicle communication apparatus 1 will be described in detail.

DSRC in-vehicle communication apparatus 1 configured as shown in FIG. 1 operates in the same way as a conventional DSRC roadside device when base station function section 3 is selected by means of a operation function selection section 2 setting and operation as a base station is selected. That is to say, in this case, base station function section 3 of DSRC in-vehicle communication apparatus 1 repeatedly transmits FCMC data comprising a DSRC communication frame control signal to a mobile station via link connection/communication function section 5.

Next, a case will be described in which a vehicle equipped with DSRC in-vehicle communication apparatus 1 operating as a base station moves to the vicinity of a vehicle equipped with a mobile station function (this vehicle hereinafter being referred to as a “mobile station”), such that the two vehicles approach each other.

When DSRC in-vehicle communication apparatus 1 operating as a base station approaches the mobile station, and base station function section 3 of DSRC in-vehicle communication apparatus 1 operating as a base station detects a received field strength of a certain value or above, base station function section 3 detects whether or not an ACTC—that is, a channel affiliation request—is received at predetermined timing after FCMC data transmission. On the other hand, when DSRC in-vehicle communication apparatus 1 operating as a base station approaches the mobile station, and base station function section 3 of DSRC in-vehicle communication apparatus 1 operating as a base station detects a received field strength of a certain value or above, the mobile station starts an FCMC reception standby operation. Then, when base station function section 3 of DSRC in-vehicle communication apparatus 1 operating as a base station receives FCMC data during an FCMC reception standby operation, base station function section 3 performs a frequency selection operation. After completion of the frequency selection operation, the mobile station transmits ACTC data—that is, a channel affiliation request signal—to DSRC in-vehicle communication apparatus 1 operating as a base station in accordance with slot information defined in the received FCMC data.

Link connection/communication function section 5 of DSRC in-vehicle communication apparatus 1 operating as a base station receives the ACTC data from the mobile station and outputs that ACTC data to base station function section 3. Base station function section 3 recognizes the link address of the mobile station making the channel affiliation request.

When base station function section 3 of DSRC in-vehicle communication apparatus 1 operating as a base station recognizes the link address of the mobile station making the channel affiliation request, DSRC in-vehicle communication apparatus 1 operating as a base station recognizes the presence of a mobile station as an in-vehicle communication apparatus DSRC communication object. By this means, a link connection is established between DSRC in-vehicle communication apparatus 1 operating as a base station and the relevant mobile station making the channel affiliation request. After the link connection has been established, DSRC in-vehicle communication apparatus 1 operating as a base station transmits FCMC data assigning a transmit/receive slot to the mobile station. When the mobile station receives the FCMC data, point-to-point communication conforming to the DSRC communication standard becomes possible between DSRC in-vehicle communication apparatus 1 operating as a base station and the mobile station.

Next, a case will be described in which a user operates operation function selection section 2, and mobile station function section 4 is selected by operation function selection section 2. In this case, DSRC in-vehicle communication apparatus 1 operates in the same way as a mobile station conforming to the DSRC communication standard. That is to say, in this case, DSRC in-vehicle communication apparatus 1 operating as a mobile station constantly monitors received field strength. A vehicle equipped with DSRC in-vehicle communication apparatus 1 operating as a mobile station moves to the vicinity of a vehicle equipped with a base station function (this vehicle hereinafter being referred to as a “base station”), such that the two vehicles approach each other. Then, when mobile station function section 4 of DSRC in-vehicle communication apparatus 1 operating as a mobile station detects a received field strength of a certain value or above, mobile station function section 4 starts an FCMC reception standby operation.

When mobile station function section 4 of DSRC in-vehicle communication apparatus 1 operating as a mobile station receives first-time FCMC data during the FCMC reception standby operation, mobile station function section 4 stores an FID (identification number field) that is in the received FCMC data. Then mobile station function section 4 analyzes the FCMC reception timing of the next frame from received fixed data slot information, performs second-time FCMC reception via link connection/communication function section 5, and stores the FID.

Next, when mobile station function section 4 of DSRC in-vehicle communication apparatus 1 operating as a mobile station confirms that the FIDs of the first-time and second-time FCMC data match, DSRC in-vehicle communication apparatus 1 operating as a mobile station determines that data reception from the base station has been accomplished correctly.

On the other hand, if, in the FCMC reception standby state, mobile station function section 4 of DSRC in-vehicle communication apparatus 1 operating as a mobile station cannot receive FCMC data at all for a certain period or longer, or cannot receive second-time data, or if the FID of FCMC data received the second time does not match, etc., DSRC in-vehicle communication apparatus 1 operating as a mobile station determines that data reception from the base station has not been accomplished correctly at the set reception frequency.

If data reception from the base station has not been accomplished correctly, mobile station function section 4 of DSRC in-vehicle communication apparatus 1 operating as a mobile station changes the reception frequency setting, and performs an FCMC reception standby operation again. Seven reception frequencies are stipulated in the DSRC communication standard. In this way, mobile station function section 4 of DSRC in-vehicle communication apparatus 1 operating as a mobile station receives FCMC data from the base station a second time, and repeats reception frequency setting changes and FCMC reception standby, and performs frequency selection operations, until an FID match is confirmed. After frequency selection is completed, mobile station function section 4 of DSRC in-vehicle communication apparatus 1 operating as a mobile station transmits an ACTC in a slot defined by the received FCMC data via link connection/communication function section 5, and has the base station recognize the mobile station's link address.

Specifically, the base station receives the ACTC transmitted by DSRC in-vehicle communication apparatus 1 operating as a mobile station, and recognizes the link address of DSRC in-vehicle communication apparatus 1 operating as a mobile station in the ACTC data. At this point, the base station completes recognition of the presence of DSRC in-vehicle communication apparatus 1 operating as a mobile station. In this way, a link connection is established by the base station and DSRC in-vehicle communication apparatus 1 operating as a mobile station recognizing each other's presence, and point-to-point DSRC communication conforming to the DSRC communication standard becomes possible between the base station and DSRC in-vehicle communication apparatus 1 operating as a mobile station.

Next, a description will be given of the case of a setting for operation whereby whether DSRC in-vehicle communication apparatus 1 operates as a base station or a mobile station according to an operation function selection section 2 setting is determined and decided by data transmission and reception between DSRC in-vehicle communication apparatuses. In this case, initially, since DSRC in-vehicle communication apparatus 1 has not been set to either a base station operating mode or a mobile station operating mode, link connection/communication function section 5 repeats FCMC transmission, ACTC reception standby, and FCMC reception standby operations, through linkage to base station function section 3 and mobile station function section 4. Such a setting is hereinafter referred to as a both-mode setting. A both-mode setting DSRC in-vehicle communication apparatus 1 monitors received field strength, and does not perform a receive operation unless field strength of a certain value or above is detected.

When a both-mode setting DSRC in-vehicle communication apparatus 1 and a base station approach each other, the base station continues FCMC transmission, and both-mode setting DSRC in-vehicle communication apparatus 1 repeats FCMC transmission, ACTC reception standby, and FCMC reception standby operations.

In this case, the base station does not receive FCMC data transmitted by both-mode setting DSRC in-vehicle communication apparatus 1 since FCMC reception is not stipulated in the DSRC communication standard.

On the other hand, since both-mode setting DSRC in-vehicle communication apparatus 1 repeats FCMC transmission, ACTC reception standby, and FCMC reception standby operations, FCMC reception is possible when the transmission timing of an FCMC transmitted by the base station and the timing of a both-mode setting DSRC in-vehicle communication apparatus 1 FCMC reception standby operation coincide. Once link connection/communication function section 5 of both-mode setting DSRC in-vehicle communication apparatus 1 performs FCMC reception from the base station, operation function selection section 2 of both-mode setting DSRC in-vehicle communication apparatus 1 determines itself to be a mobile station, and selects mobile station function section 4. Consequently, both-mode setting DSRC in-vehicle communication apparatus 1 starts operating as a mobile station. Therefore, both-mode setting DSRC in-vehicle communication apparatus 1 performs FID matching and frequency selection after FCMC reception, and can operate as a normal mobile station.

Next, a case will be described in which a both-mode setting DSRC in-vehicle communication apparatus 1 operates as a base station.

When a both-mode setting DSRC in-vehicle communication apparatus 1 and a mobile station approach each other while both-mode setting DSRC in-vehicle communication apparatus 1 is repeating FCMC transmission, ACTC reception standby, and FCMC reception standby operations, the mobile station detects a change in the field strength due to FCMC transmission by both-mode setting DSRC in-vehicle communication apparatus 1, and starts an FCMC reception standby operation and frequency selection operation. When the mobile station's frequency selection operation is completed, the mobile station recognizes both-mode setting DSRC in-vehicle communication apparatus 1 as a base station transmitting FCMC data. Then the mobile station performs ACTC transmission to both-mode setting DSRC in-vehicle communication apparatus 1 at the slot timing defined by the FCMC data.

At this time, both-mode setting DSRC in-vehicle communication apparatus 1 is performing FCMC transmission, ACTC reception standby, and FCMC reception standby operations through linkage of operation function selection section 2, base station function section 3, mobile station function section 4, and link connection/communication function section 5, and therefore link connection/communication function section 5 receives the ACTC transmitted by the mobile station. Through the reception of this ACTC, operation function selection section 2 of both-mode setting DSRC in-vehicle communication apparatus 1 determines that both-mode setting DSRC in-vehicle communication apparatus 1 should operate as a base station, and selects base station function section 3. After this determination, a link connection is established between both-mode setting DSRC in-vehicle communication apparatus 1 operating as a base station and the mobile station, and therefore the two can operate as a DSRC communication base station and mobile station.

Next, a case will be described in which a plurality of both-mode setting DSRC in-vehicle communication apparatuses 1 for which neither a mobile station function nor a base station function has been selected approach each other. In this case, initially, all DSRC in-vehicle communication apparatuses 1 repeat FCMC transmission, ACTC reception standby, and FCMC reception standby operations in turn. However, the operations of all DSRC in-vehicle communication apparatuses 1 are not initially synchronized. In this case, therefore, a both-mode setting DSRC in-vehicle communication apparatus 1 receives FCMC data transmitted by a counterpart DSRC in-vehicle communication apparatus 1 according to mutual FCMC transmission and FCMC reception standby timing, and determines and decides that it is itself a mobile station. Operation function selection section 2 of DSRC in-vehicle communication apparatus 1 that has determined itself to be a mobile station selects mobile station function section 4. By this means, one of the DSRC in-vehicle communication apparatuses 1 for which neither a mobile station function nor a base station function had initially been selected starts operating as a mobile station. Next, after completion of a frequency selection operation, DSRC in-vehicle communication apparatus 1 that has started operating after determining itself to be a mobile station in this way transmits an ACTC to its counterpart in accordance with the received FCMC data. Accordingly, operation function selection section 2 of the counterpart both-mode setting DSRC in-vehicle communication apparatus 1 receives the ACTC via link connection/communication function section 5, determines itself to be a base station, and selects base station function section 3. From this point onward, that DSRC in-vehicle communication apparatus 1 starts operating as a base station.

Thus, when a DSRC in-vehicle communication apparatus 1 functioning as a base station receives an ACTC and recognizes the link address of its counterpart, a link connection as base station and mobile station is established. Consequently, it is thereafter possible for a plurality of both-mode setting DSRC in-vehicle communication apparatuses 1 to operate respectively as a base station and mobile station performing DSRC communication in accordance with the DSRC communication standard.

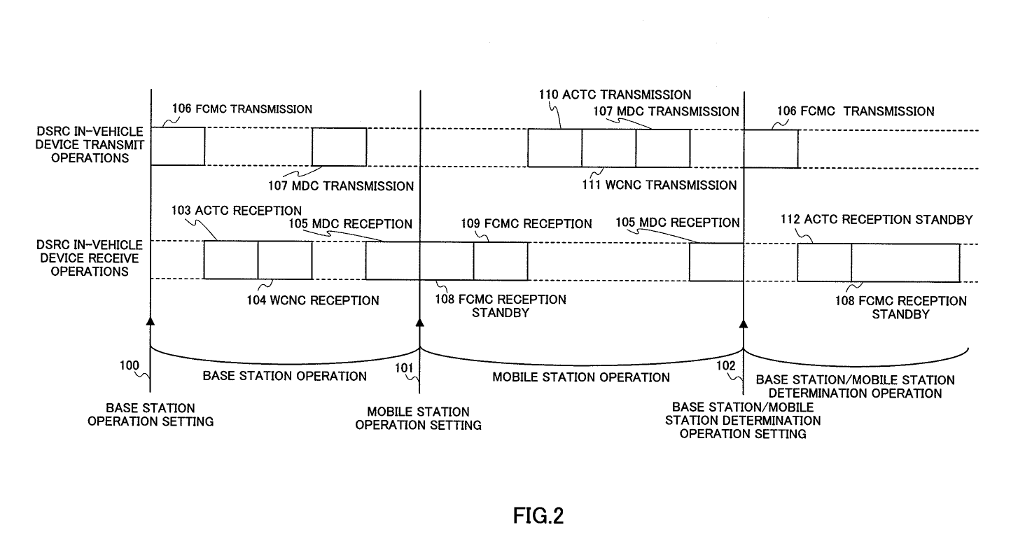

FIG. 2 is a drawing explaining the operation of an inter-vehicle communication system according to Embodiment 1. FIG. 2 shows the timing of signals transmitted and received for performing DSRC communication when DSRC in-vehicle communication apparatus 1 shown in FIG. 1 has been selected to operate as a base station, when DSRC in-vehicle communication apparatus 1 shown in FIG. 1 has been selected to operate as a mobile station, and when DSRC in-vehicle communication apparatus 1 shown in FIG. 1 has been selected to operate while determining whether to operate as a base station or to operate as a mobile station. The operation of an inter-vehicle communication system according to Embodiment 1 is described below with reference to FIG. 2.

When a DSRC in-vehicle communication apparatus 1 is set to operate as a base station by means of a base station operation setting directive 100 from operation function selection section 2 of DSRC in-vehicle communication apparatus 1, link connection/communication function section 5 performs ACTC reception 103, WCNC reception 104, and MDC reception 105 operations as base station receive operations, and repeatedly performs FCMC transmission 106 and MDC transmission 107 operations as base station transmit operations.

When, as a result of these operations, link connection/communication function section 5 performs ACTC reception during ACTC reception standby, operation function selection section 2 selects base station function section 3. Accordingly, the relevant DSRC in-vehicle communication apparatus 1 operates as a base station from this point onward.

When a DSRC in-vehicle communication apparatus 1 is set to operate as a mobile station by means of a mobile station operation setting directive 101 from operation function selection section 2 of DSRC in-vehicle communication apparatus 1, DSRC in-vehicle communication apparatus 1 performs FCMC reception standby 108, FCMC reception 109, and MDC reception 105 as mobile station receive operations. Also, DSRC in-vehicle communication apparatus 1 performs ACTC transmission 110, WCNC transmission 111, and MDC transmission 107 operations as mobile station transmit operations.

When, as a result of these operations, link connection/communication function section 5 performs FCMC reception during FCMC reception standby 108, operation function selection section 2 selects mobile station function section 4. Accordingly, the relevant DSRC in-vehicle communication apparatus 1 operates as a mobile station from this point onward.

When a DSRC in-vehicle communication apparatus 1 is set, by means of a base station/mobile station determination operation setting directive 102 from operation function selection section 2 of DSRC in-vehicle communication apparatus 1, to operate by determining whether to operate as a base station or as a mobile station based on the result of DSRC communication, DSRC in-vehicle communication apparatus 1 performs ACTC reception standby 112 and FCMC reception standby 108 operations as receive operations. Also, DSRC in-vehicle communication apparatus 1 performs FCMC transmission 106 as a transmit operation.

If, as a result of these operations, link connection/communication function section 5 performs ACTC reception during ACTC reception standby 112, and operation function selection section 2 selects base station function section 3, the relevant DSRC in-vehicle communication apparatus 1 operates as a base station from this point onward. On the other hand, if link connection/communication function section 5 receives an FCMC during FCMC reception standby 108, and operation function selection section 2 selects mobile station function section 4, the relevant DSRC in-vehicle communication apparatus 1 determines that it should operate as a mobile station from this point onward, and then performs operation as a mobile station.

As described above, according to an inter-vehicle communication system of Embodiment 1, inter-vehicle communication is possible between arbitrary DSRC in-vehicle communication apparatuses 1.

Furthermore, a DSRC in-vehicle communication apparatus 1 according to Embodiment 1 is configured to allow selection of a mobile station function or base station function conforming to the standard DSRC communication standard, and employs a configuration that has a function for link connection between a plurality of DSRC in-vehicle communication apparatuses. Therefore, according to a communication system of Embodiment 1, it is possible to implement communication with a DSRC communication standard communication device and communication infrastructure, enabling a highly versatile and scalable inter-vehicle communication system to be implemented.

Moreover, according to a communication system of Embodiment 1, it is possible to provide inter-vehicle communication service using DSRC communication at a location with no DSRC roadside device, which is not possible with conventional DSRC communication. For example, it is possible to implement driving support such as pinpointing the location of a vehicle by means of GPS, and sharing that information by means of inter-vehicle communication, displaying the position of a nearby vehicle on a car navigation system screen, notifying a driver of the approach of a nearby vehicle, and so forth. In addition, data sharing such as the sharing of accumulated map data, store/restaurant information, music, images, and so forth, and the provision of services such as transmitting emergency information or traffic information including congestion and accident advisories by hopping between DSRC in-vehicle communication apparatuses, are also possible in conformity with the DSRC standard constituting a standard communication specification.

Furthermore, a DSRC in-vehicle communication apparatus 1 according to Embodiment 1 is equipped with base station and mobile station implementation functions, and a function whereby DSRC in-vehicle communication apparatus 1 operates by determining whether to operate as a base station or a mobile station, and employs a configuration that enables switching among base station operation, mobile station operation, and base station/mobile station determination operation, as necessary. As a result, it is possible, for example, for DSRC communication to be executed regardless of whether another station with which DSRC communication is being attempted is a base station or a mobile station, and even if it is not known whether that station is a base station or a mobile station.

### Embodiment 2

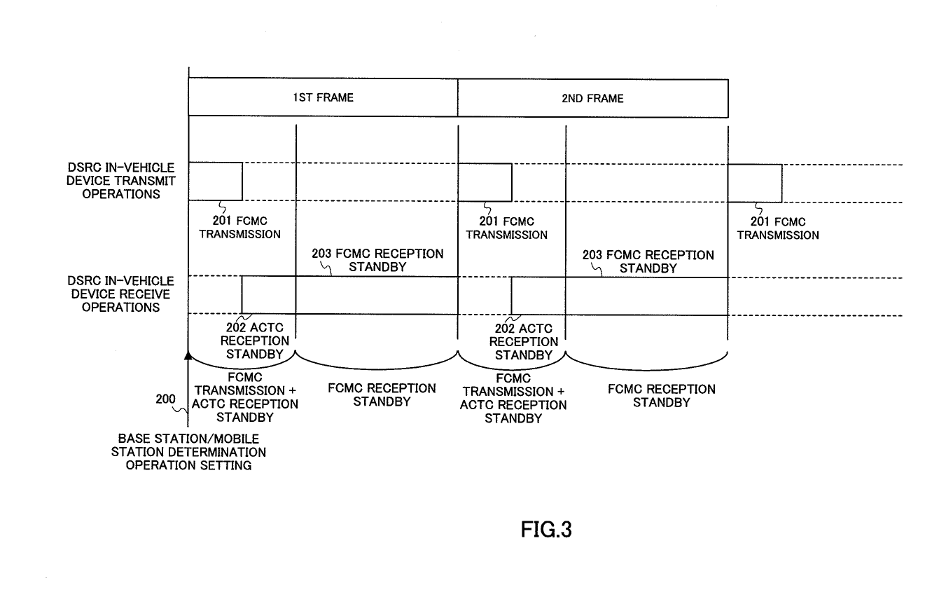

FIG. 3 is a drawing explaining the operation of an inter-vehicle communication system according to Embodiment 2 of the present invention. The operation of an inter-vehicle communication system according to Embodiment 2 is described below with reference to FIG. 3. A DSRC in-vehicle communication apparatus used in an inter-vehicle communication system according to Embodiment 2 has the same configuration as DSRC in-vehicle communication apparatus 1 shown in FIG. 1, and Embodiment 2 is described below using the reference codes in FIG. 1.

When a DSRC in-vehicle communication apparatus 1 is set to operate by determining whether to operate as a base station or as a mobile station by means of a base station/mobile station determination operation setting directive 200 from operation function selection section 2 of DSRC in-vehicle communication apparatus 1, DSRC in-vehicle communication apparatus 1 performs FCMC transmission 201, ACTC reception standby 202, and FCMC reception standby 203 operations.

With regard to the slot configuration at this time, as shown in FIG. 3, FCMC transmission 201 is performed in the first slot of each frame in the same way as for a base station based on the DSRC communication standard, and ACTC reception standby 202 is performed in slots other than the first slot. At this time, transmitted FCMC data slot information is set so that a communicating-party mobile station performs ACTC transmission in a slot in which the station itself performs an ACTC reception standby operation.

By configuring a DSRC in-vehicle communication apparatus 1 in this way, when a communicating-party mobile station receives an FCMC, it is possible for DSRC in-vehicle communication apparatus 1 to perform ACTC reception in a predetermined slot. Also, as shown in FIG. 3, within one frame, an FCMC reception standby 203 operation is performed at timing other than FCMC transmission 201 and ACTC reception standby 202 timing. By using many FCMC reception standby 203 times in this way, when the communicating party is a base station and the communicating party performs FCMC transmission, DSRC in-vehicle communication apparatus 1 can have many opportunities to receive that data.

Although these operations are shown only in the first frame and second frame in FIG. 3, they continue for any number of frames until DSRC in-vehicle communication apparatus 1 receives an FCMC or receives an ACTC. By this means, it is possible for DSRC in-vehicle communication apparatus 1 to determine and decide whether to operate as a base station or as a mobile station in DSRC communication.

As described above, according to Embodiment 2, by means of a DSRC communication method whereby FCMC transmission and ACTC reception standby operations, and FCMC reception standby operations, are executed alternately, a highly flexible inter-vehicle communication system using DSRC in-vehicle communication apparatuses 1 can be implemented.

### Embodiment 3

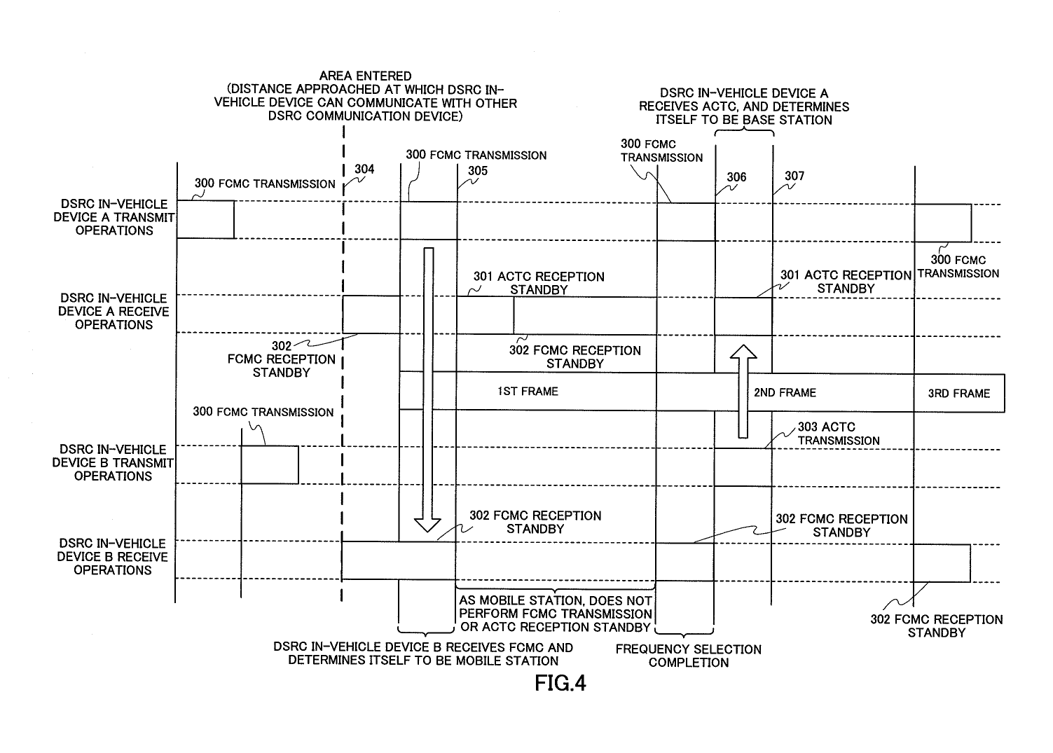

FIG. 4 is a drawing explaining the operation of an inter-vehicle communication system according to Embodiment 3 of the present invention. FIG. 4 illustrates a case in which a pair of DSRC in-vehicle communication apparatuses shown in FIG. 1 are present. In FIG. 4, this pair of DSRC in-vehicle communication apparatuses are designated DSRC in-vehicle communication apparatus A and DSRC in-vehicle communication apparatus B. In Embodiment 3, it is not initially established whether this pair of DSRC in-vehicle communication apparatuses A and B operate as a base station or mobile station, and both are set as operating as determined by means of communication. However, to make the drawing easier to understand, it will here be assumed that DSRC in-vehicle communication apparatus A finally sets its operation after determining itself to be a base station, and DSRC in-vehicle communication apparatus B finally sets its operation after determining itself to be a mobile station.

The operation of an inter-vehicle communication system according to Embodiment 3 is described below based on FIG. 4.

First, DSRC in-vehicle communication apparatus A and DSRC in-vehicle communication apparatus B both monitor the received field strength, and check for the approach of a counterpart. Initially, the received field strength is not above a certain level, and therefore DSRC in-vehicle communication apparatus A and DSRC in-vehicle communication apparatus B perform only FCMC transmission 300.

After a while, DSRC in-vehicle communication apparatus A and DSRC in-vehicle communication apparatus B approach each other, and when their respective monitored received field strengths exceed a certain level according to their respective receive data, DSRC in-vehicle communication apparatuses A and B detect that they have entered an area 304 in which communication is possible.

Then DSRC in-vehicle communication apparatus A and DSRC in-vehicle communication apparatus B repeat FCMC transmission 300, ACTC reception standby 301, and FCMC reception standby 302 in order to determine whether to operate as a base station or to operate as a mobile station.

Next, the timings of DSRC in-vehicle communication apparatus A FCMC transmission 300 and DSRC in-vehicle communication apparatus B FCMC reception standby 302 coincide, and DSRC in-vehicle communication apparatus B performs FCMC reception at FCMC reception timing 305. According to this FCMC reception, DSRC in-vehicle communication apparatus B determines itself to be a mobile station, and from this point onward performs communication operation as a normal mobile station.

At the timing at which DSRC in-vehicle communication apparatus B starts operating as a mobile station in this way, as shown in FIG. 4, DSRC in-vehicle communication apparatus A has not been able to determine whether it is a base station or a mobile station, and continues to repeat FCMC transmission 300, ACTC reception standby 301, and FCMC reception standby 302.

DSRC in-vehicle communication apparatus B then performs second-time FCMC reception in the frame after the frame in which an FCMC was first received, and confirms a match between the FID of the initially received FCMC data and the FID of the FCMC data received the second time. Having confirmed that the FIDs match, DSRC in-vehicle communication apparatus B completes a frequency selection operation at frequency selection completion timing 306, and DSRC communication with DSRC in-vehicle communication apparatus A becomes possible.

After the frequency selection operation is completed, DSRC in-vehicle communication apparatus B starts DSRC communication in accordance with received FCMC data slot information.

DSRC in-vehicle communication apparatus B then transmits an ACTC in the slot defined by the FCMC data transmitted by DSRC in-vehicle communication apparatus A.

Then DSRC in-vehicle communication apparatus A performs ACTC reception at ACTC reception timing 307. Based on this ACTC reception, DSRC in-vehicle communication apparatus A determines itself to be a base station, and thereafter performs operation as a base station.

In this way, DSRC in-vehicle communication apparatus A and DSRC in-vehicle communication apparatus B each determine whether to operate as a base station or a mobile station by performing DSRC communication, and continue communication conforming to the DSRC communication standard.

Thus, in an inter-vehicle communication system according to Embodiment 3, in addition to being able to obtain the effects provided by an inter-vehicle system of Embodiment 1, since, even though DSRC in-vehicle communication apparatus operation has not been established initially, DSRC in-vehicle communication apparatuses can perform communication operations after determining and deciding autonomously that one is to be a base station and the other a mobile station in accordance with the content of communication with each other, and flexible inter-vehicle communication can be implemented that reflects DSRC in-vehicle communication apparatus operations, functions, conditions, objectives, and so forth. Therefore, an inter-vehicle communication system according to Embodiment 3 is particularly effective when many DSRC in-vehicle communication apparatuses are installed and system specifications are not established beforehand, such as when constructing a very large inter-vehicle communication system, for example, or when beginning construction of a communication system to be expanded into a very large inter-vehicle system at some time in the future.

Also, according to an inter-vehicle communication system of Embodiment 3, by using DSRC in-vehicle communication apparatuses whose operation can be set after determining whether to operate as a base station or a mobile station, link connection is possible not only between DSRC in-vehicle communication apparatuses with the same setting but also with a conventional DSRC roadside device or DSRC in-vehicle communication apparatus. That is to say, a conventional DSRC roadside device is a base station, and therefore a DSRC in-vehicle communication apparatus with a setting determining whether to operate as a base station or to operate as a mobile station always determines itself to be a mobile station, and in the case of a conventional DSRC in-vehicle communication apparatus the station is a mobile station, and therefore a DSRC in-vehicle communication apparatus with a setting determining whether to operate as a base station or to operate as a mobile station always determines itself to be a base station. By using this method, communication with any vehicle equipped with a DSRC in-vehicle communication apparatus becomes possible while maintaining the ability to execute link connection to a conventional DSRC in-vehicle communication apparatus.

As described above, according to the present invention inter-vehicle communication using DSRC communication can be performed between arbitrary vehicles.

What is claimed is:

1. An inter-vehicle communication method comprising:
a frame control signal transmitting step of one of a plurality of in-vehicle communication apparatuses having functions of both a base station and a mobile station transmitting a frame control signal;
a step of said in-vehicle communication apparatus that receives said frame control signal during a frame control signal reception standby operation analyzing received said frame control signal;
a step of, when said in-vehicle communication apparatus that transmitted said frame control signal can be recognized by means of said analysis, transmitting a channel affiliation request signal containing that station's own address;
a step of said in-vehicle communication apparatus that transmitted said frame control signal receiving said channel affiliation request signal during a channel affiliation request reception standby operation and functioning as a base station correspondent in-vehicle communication apparatus; and
an inter-vehicle communication step of said base station correspondent in-vehicle communication apparatus and a mobile station correspondent in-vehicle communication apparatus that is said in-vehicle communication apparatus of an address of said channel affiliation request signal performing dedicated short-range communication.

2. An in-vehicle communication apparatus comprising:
an operation function selection section that selects operation as a mobile station on receiving a frame control signal during a frame control signal reception standby operation, and selects operation as a base station on receiving a channel affiliation request signal during channel affiliation request signal reception standby after transmitting said frame control signal;
a base station function implementation section that, when operation as a base station has been selected by said operation function selection section, performs communication with a mobile station of an address contained in received said channel affiliation request signal; and
a mobile station function implementation section that, when operation as a mobile station has been selected by said operation function selection section, transmits said channel affiliation request signal containing that station's own address when a base station can be recognized by analyzing received said frame control signal, and performs communication with a base station.

3. The in-vehicle communication apparatus according to claim 2, wherein said operation function selection section performs sequential and repeated control of said frame control signal transmit operation, said channel affiliation request signal reception standby operation, and said frame control signal standby operation, in order to perform said selection.
